(19) United States
(12) Patent Application Publication
(10) Pub. No.: US 2007/0214967 A1
(43) Pub. Date: Sep. 20, 2007

(54) Tempertature Sensor for a Cooking Device, Cooking Device With Electronic Control and Method for Temperature Recording

(75) Inventors: Uwe Has, Unterneukirchen (DE); Peter Vetterl, Grabenstatt (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/587,561

(22) PCT Filed: May 13, 2005
(86) PCT No.: PCT/EP05/52199

§ 371 Date: Oct. 26, 2006

(30) Foreign Application Priority Data
May 13, 2004 (DE) 10 2004 023 846.4

(51) Int. Cl. A47J 27/00; G01J 5/00

(52) U.S. Cl. 99/358; 374/121

(57) ABSTRACT

A temperature sensor on a cooking device, for non-contact recording of a temperature of a cooking utensil includes at least one infra red-sensor, with at least two differing sensitivity ranges for recording at least two different wavelengths emitted by the cooking utensil. The infra-red sensor can be a multi-channel pyrometer. In accordance with a method for non-contact recording of a temperature of a cooking utensil, at least two different wavelength ranges emitted by the cooking utensil are recorded by an infra-red sensor comprising a multi-channel pyrometer.

The present invention relates to a temperature sensor for a cooking device according to the preamble of claim 1 for non-contact recording of a temperature of a cooking utensil. The invention further relates to a cooking device having the features of claim 3 and a method for non-contact recording of a temperature of a cooking utensil having the features of claim 5.

More simply equipped cooking devices do not have circuits for regulating a cooking temperature. The cooking temperature can only be coarsely pre-selected by means of adjusting devices. During the cooking process the temperature at the hot plate then fluctuates to a greater or lesser extent. In better equipped cooking devices, a control circuit can be provided to keep a pre-selected temperature constant. A necessary input quantity is a measured temperature at the cooking surface and/or at the cooking utensil.

Known non-contact temperature sensors are used to record the temperatures of cooking utensils located on the cooking surfaces in cooking devices. Known temperature sensors comprise an infrared sensor which records the temperature of the outer wall of the cooking utensil in a wavelength range of about 6 μm to about 14 μm by means of a continuous light pyrometer. The electrical signal supplied by the infrared sensor for the electronic control depends directly on the emittance of the pot side being considered. In order to achieve a signal which is as reliable as possible and free from interference, this emittance must be known exactly in the wavelength range being considered. This emittance in the wavelength range being considered is also designated as band emittance.

However, the emittances of different cooking utensils differ as a result of the different materials in some cases. The emittance of stainless steel pots differs substantially from the emittance of enamelled pots. Using pots having an unsuitable enamel coating causes a shift of the food temperatures achieved in the pot. This is caused by fluctuations in the band emittance of the enamel coating. Contaminants on the coating can present problems when making an exact determination.

A method for non-contact radiation measurement of the object temperature independent of the emittance of the object being considered is known from EP 01 143 282 A. A method for recording a temperature distribution of a cooking utensil is furthermore known from EP 1 302 759 A.

An object of the present invention is to provide a non-contact sensor for recording a cooking utensil temperature which delivers a temperature signal which is as reliable as possible.

This object is achieved with the subject matter of the independent claim. A temperature sensor of a cooking device according to the invention for non-contact recording of a temperature of a cooking utensil comprises at least one infrared sensor for recording at least two different wavelength ranges which are emitted by the cooking utensil. In particular, a multi-channel pyrometer disposed on a hot plate in the immediate vicinity of the cooking utensil can be considered as an infrared sensor of this type. It is hereby possible to obtain a reliable prediction of the temperature inside the cooking utensil even for different materials of the cooking utensil.

An infrared sensor of this type records thermal radiation emitted by the object being considered in a defined wavelength range λ (where λ₁≦λ≦λ₂) and converts this into an electrical signal. The electrical signal S₁₂(T) delivered by the infrared sensor uniquely designates the temperature of the surface being considered. The band emittance ε₁₂ of the surface being considered is contained as a multiplicative factor in the recorded signal S₁₂(T). The signal S₁₂(T) can be deduced according to the following equation (1)
S₁₂(T)=S_{P,12}(T)*ε₁₂*C₁₂,
where the term S_{P,12}(T) is the theoretical signal of a Planck emitter in the wavelength range (λ₁≦λ≦λ₂) being considered. The factor C₁₂ is a correction factor from the optics of the sensor or from the size of the surface being considered for the measurement.

Assuming that in two separate wavelength ranges λ₁≦λ≦λ₂ and λ₃≦λ≦λ₄ (where λ₂<λ₃), the two respective band transmittances ε₁₂ and ε₃₄ are approximately the same, from the above equation (1) a ratio of the two signals S₁₂(T) and S₃₄(T) corresponding to the following equation (2) can be formed from the output signals

$$\begin{matrix}{S}_{12 / 34} ( T ) = ( {S}_{P , 12} ( T ) * {ɛ}_{12} * {C}_{12} ) / ( {S}_{P , 34} ( T ) * {ɛ}_{34} * {C}_{34} ) \\ = ( {S}_{P , 12} ( T ) * {C}_{12} ) / ( {S}_{P , 34} ( T ) * {C}_{34} ) .\end{matrix}$$

This allows an actual temperature of the object surface being considered to be determined relatively reliably even if the band emittances are different. In addition, since the two factors which depend on the optics used in each case and the sizes of the surfaces being considered are known, equation (2) is reduced to the following equation (3):
S_{12/34}(T)=S_{P,12}(T)/S_{P,34}(Y)*C_{Optik}

In this equation (3) the factor C_{Optik} is merely contained as a general factor which describes the special properties of the two pyrometer channels. The calculated value S_{12/34}(T) is a relatively reliable measure for the temperature of the surface being considered. The invention thus makes it possible to record the cooking temperature independently of the material. In this case, there are no problems with fluctuating enamel qualities or with different materials of the cooking utensils used since the infrared cooking sensor is independent of the type of cooking utensil used.

If the two band emittances ε₁₂ and ε₃₄ are not the same, the following equation (4)
C_{ε}=ε₁₂/ε₃₄
can then be used to determine a factor C_{ε} from a ratio of the two band emittances. According to the above equation (3), the signal ratio S_{12/34}(T) can thus be determined nevertheless and specifically in accordance with the following equation (5):
S_{12/34}(T)=S_{P,12}(T)/S_{P,34}(T)*C_{Optik}*C_{ε}

If the accuracy achieved with these equations should not be sufficient, more than two wavelength ranges can also be considered as desired. By considering at least three separate wavelength ranges λ₁≦λ≦λ₂, λ₃≦λ≦λ₄ and λ₅≦λ≦λ₆ (where λ₂<λ₃ and λ₂<λ₃), the measurement accuracy can be increased and in addition, the reliability of a calculation according to Equation (3) can be checked. Optionally, it is even possible to estimate the ratio of the band emittances being considered. The quality of such an estimate can give very accurate values for the temperatures to be recorded in the particular application being considered since the number of different cooking utensils used is not unlimited. As a rule, the cooking sensor is only confronted with a very limited number of different materials for cooking utensils.

For a relatively precise temperature control, it can be advantageous if the individual wavelength ranges do not overlap but adjoin one another or are separated from one another. In this case, it can be advantageous for a reliable prediction of the temperature if the amounts of energy allocated to the wavelength ranges are substantially the same.

For a particularly accurate calculation of the temperature, it is preferable if the wavelength ranges have a width of at least 5 to 2 μm, in particular a width of 10 μm to 20 μm. In practice, it has been shown that a restriction of the recorded wavelength ranges to 15 μm to 20 μm is sufficient to allow a relatively precise temperature control. In this case, it is advantageous for a temperature determination which is as error-free as possible if on the one hand, the individual wavelength ranges are the same width as far as possible and at the same time, abut against one another.

The invention further relates to a cooking device comprising at least one hot plate which has an electronic temperature control whereof at least one control variable can be determined by means of a temperature sensor according to one of the previously described embodiments. The appropriate wavelength ranges for the multi-channel pyrometer of the temperature sensor can lie between 4 and 20 μm. The cooking sensor preferably comprises a multi-channel pyrometer comprising at least three measurement wavelength ranges. Optionally, more channels can also be provided.

The invention finally relates to a method for non-contact recording of a temperature of a cooking utensil wherein at least two different wavelength ranges emitted by the cooking utensil can be recorded by means of an infrared sensor.

The advantage of the sensor according to the invention is that no more problems can arise with fluctuating enamel qualities, different materials, different preliminary damage to the cooking utensils, etc. The cooking sensor is relatively independent of the type of cooking utensil used.

Further embodiments and advantages of the invention can be deduced from the dependent claims.

The invention is explained in detail hereinafter using a preferred exemplary embodiment with reference to the appended drawings. In the figures:

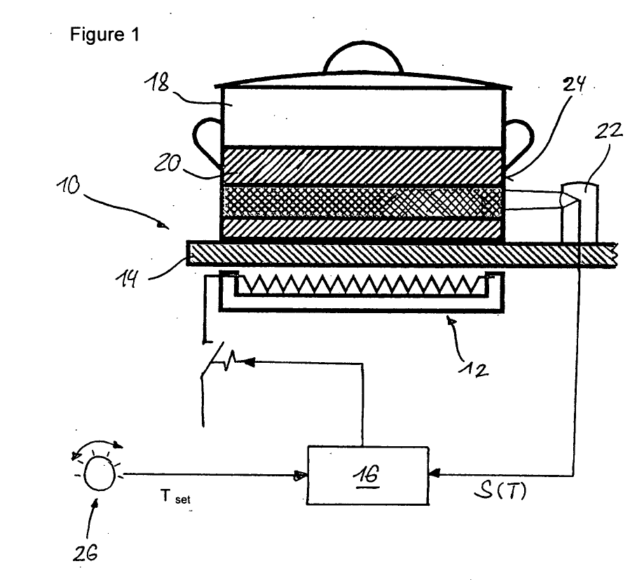

FIG. 1 is a schematic diagram of a hot plate provided with a temperature sensor according to the invention,

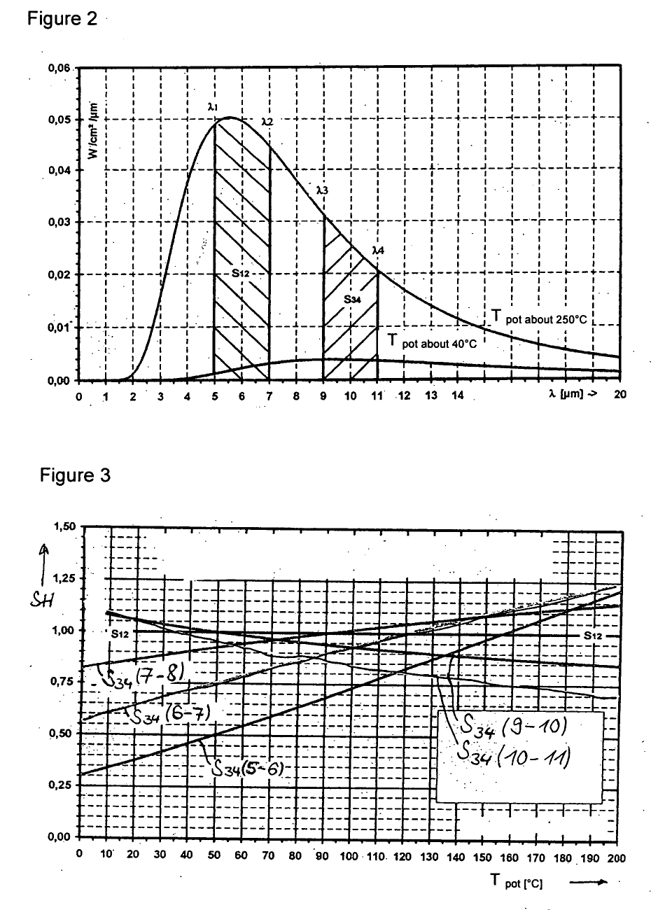

FIG. 2 is a diagram showing a relationship between a temperature of a cooking utensil and radiation energy emitted by said utensil and set

FIG. 3 is a further diagram showing different signal travel profiles of a black body emitter at different temperatures or wavelength ranges.

FIG. 1 illustrates a hot plate 10 of a cooking device which comprises a heating device 12 underneath a glass ceramic plate 14. The heating power of the electrical heater 12 can be adjusted by means of an electronic control circuit 16. Located on the hot plate 10 is a cooking utensil 18 with food 20 contained therein. An infrared sensor 22 which records a temperature at an outer wall 24 of the cooking utensil 18 in a non-contact manner is provided to record the temperature of the food 20 in the cooking utensil 18 as accurately as possible.

At least two input quantities are processed in the control circuit 16. These are, firstly, a pre-selected cooking temperature Tₛₑₜ pre-selected by the user by means of an input device 26. Secondly, the control circuit records a measured signal supplied by the infrared sensor 22. The infrared sensor 22 preferably comprises a multi-channel pyrometer whose electric output signals S(T) are evaluated in the control circuit 16 and from which any compensation is calculated so that the temperatures of the food 20 can be reliably determined for different materials of the cooking utensil 18.

The diagram in FIG. 2 illustrates a qualitative relationship between the output signals of the sensor in different wavelength ranges and at different temperatures of the cooking utensil for the example of a so-called black body emitter. The relationships between the thermal energy emitted by the cooking utensil at different wavelengths are shown. The wavelength λ in the range between 0 and 20 μm is plotted on the abscissa. The energy (in W/cm²/μm) of the cooking utensil as a black-body emitter is plotted on the ordinate.

It can be clearly seen that at a cooking utensil temperature of about 40° C. (Tₚₒₜ≈40° C.) no useable predictions can be made on the thermal energy emitted at different wavelengths. At an elevated temperature of the cooking utensil of about 250° C. (Tₚₒₜ∓250° C.), however, a specific energy maximum occurs in the wavelength range being considered between 5 μm (λ₁) and 7 μm (λ₂), from which a signal S₁₂ can be obtained. Likewise, a useable signal S₃₄ can also be obtained in the further wavelength range being considered between 9 μm (λ₃) and 11 μm (λ₄), from which a probable temperature of the cooking utensil can be derived with relatively good accuracy using equations (1) to (5) presented above.

The temperature recording of the food cooking in the cooking utensil is based on previously measured specific temperature profiles for different materials, coatings, reflectances and wall thicknesses of cooking utensils typically used in practice. The cooking utensil used can be concluded with a high probability from the specific signal profiles from which the temperatures thereof can be derived from allocation specifications stored in the control circuit.

The diagram in FIG. 3 illustrates a series of signal travel profiles when considering a black body. These profiles can be confirmed by rough calculations. It is clear here that a signal travel in the order of magnitude of 3 to 5 can be reckoned on for infrared measurements in a temperature range of about 40° C. to about 200° C. (within a wavelength range of about 5 μm to about 16 μm). Whereas a pot temperature (Tₚₒₜ) in a range of 0° C. to 200° C. is plotted on the abscissa in the diagram in FIG. 3, the ordinate shows the predicted signal travel SH. Whilst the horizontal curve describes the signal S₁₂ in a wavelength range considered between 8 μm and 9 μm, the five sloping curves indicate a signal travel SH of the second signal S₃₄ being considered, which depends on the pot temperature, in respectively different wavelength ranges. Relatively precise conclusions regarding the material being considered can be drawn from these relationships so that in reality the temperature sensor delivers a material-dependent signal that is converted into a material-independent temperature signal in the subsequent evaluation unit.

The restriction of the wavelength ranges recorded to about 5 to 15 μm is sufficient in practice to allow relatively precise temperature control. The simultaneous recording of three wavelength ranges significantly increases the quality of the control compared with recording only two ranges. Recording four or more ranges can significantly improve the quality of the temperature control still further.

### REFERENCE LIST

10 Hot plate
12 Heating device
14 Glass ceramic plate
16 Control circuit
18 Cooking utensil
20 Food
22 Infrared sensor
24 Outer wall
26 Input device

1-11. (canceled)

12. A temperature sensor of a cooking device for non-contact recording of a temperature of a cooking utensil, the temperature sensor comprising:
at least one infrared sensor having at least two different sensitivity ranges for recording at least two different wavelength ranges emitted by the cooking utensil.

13. The temperature sensor according to claim 12, wherein the infrared sensor comprises a multi-channel pyrometer.

14. The temperature sensor according to claim 12, wherein the wavelength ranges are a selected one of a group of wavelength ranges that adjoin one another and a group of wavelength ranges that are spaced apart from one another.

15. The temperature sensor according to claim 12, wherein each of the wavelength ranges is allocated substantially the same amounts of thermal energy.

16. A cooking device comprising:
at least one hot plate having an electronic temperature control with at least one control variable that can be determined by means of a temperature sensor (a) operable to record in a non-contact manner a temperature of a cooking utensil deployed in connection with cooking on the hot plate and (b) having at least one infrared sensor with at least two different sensitivity ranges for recording at least two different wavelength ranges emitted by the cooking utensil.

17. The cooking device according to claim 16, wherein the electronic temperature control has at least one control variable that can be determined by means of a temperature sensor arranged on the hotplate in the immediate vicinity of the cooking utensil.

18. A method for non-contact recording of a temperature of a cooking utensil comprising:
recording at least two different wavelength ranges emitted by the cooking utensil by means of an infrared sensor comprising a multi-channel pyrometer.

19. The method according to claim 18, wherein recording at least two different wavelength ranges emitted by the cooking utensil by means of an infrared sensor includes recording wavelength ranges lying in a range between about 4 μm to 20 μm.

20. The method according to claim 18, wherein recording at least two different wavelength ranges emitted by the cooking utensil by means of an infrared sensor includes recording at least three different wavelength ranges.

21. The method according to claim 18 and further comprising determining the temperature of the cooking utensil from signals respectively associated with the different wavelength ranges.

22. The method according to claim 18 and further comprising taking into account different band emittances of different materials of the cooking utensil when determining the temperatures.
